(19) United States
(12) Patent Application Publication
(10) Pub. No.: US 2007/0247545 A1
(43) Pub. Date: Oct. 25, 2007

(54) Auxiliary light irradiating device for photographing device, method thereof and storage medium storing program

(76) Inventors: Toshiaki Yamada, Saitama-ken (JP); Hidehiko Nakajima, Chiba-ken (JP)

Correspondence Address: TAIYO CORPORATION, 401 HOLLAND LANE, #407, ALEXANDRIA, VA, 22314, US

(21) Appl. No.: 11/657,464

(22) Filed: Jan. 25, 2007

(30) Foreign Application Priority Data
Jan. 31, 2006 (JP) 2006-023207

(51) Int. Cl. H04N 5/225

(52) U.S. Cl. 348/371; 348/E05.024

(57) ABSTRACT

The present invention provides an auxiliary light irradiating device for a photographing device provided with a light source irradiating an auxiliary light toward an object, a liquid crystal panel provided in a light path toward the object of the auxiliary light by the light source, and being configured to displaying an image at a predetermined resolution, an input section inputting application information indicating an application of the liquid crystal panel, and a control section controlling the liquid crystal panel so that a display image is changed according to the application indicated by the application information.

### CROSS-REFERENCE TO RELATED APPLICATION

This application claims priority under 35 USC 119 from Japanese Patent Application No. 2006-023207, the disclosure of which is incorporated by reference herein.

### BACKGROUND OF THE INVENTION

1. Field of the Invention

The present invention relates to an auxiliary light irradiating device for a photographing device, a method thereof and a storage medium storing a program, and more particularly to an auxiliary light irradiating device irradiating an auxiliary light toward an object to be photographed at a time of photographing by the photographing device, a method of controlling an auxiliary light irradiation, and a storage medium for storing a program thereof.

2. Description of the Related Art

In recent years, with the solid-state image sensing devices such as a charged coupled device (CCD) area sensor, a complementary metal oxide semiconductor (CMOS) image sensor or the like increasing their resolution, demands for an information device having a photographing function such as a digital electronic still camera, a digital video camera, a portable telephone, a personal digital assistant (PDA) or the like, are rapidly increasing. Herein, the information device having the photographing function as described above is generically referred as a digital camera.

In this case, in the photographing device such as the digital camera, a silver salt photograph type camera or the like as described above, a strobe light (flash lamp) is incorporated in many cases for dealing with a case that the object is dark. In this kind of photographing device, various devices are applied for adjusting (modulating) an amount of light emission of the strobe light.

As this kind of art, in Japanese patent application (Laid-Open) (JP-A) No. 2004-102086, there is disclosed an art for obtaining a proper light amount for an object by a strobe light at a time of macro photographing. In this art, a camera with a strobe light having a strobe light device irradiating an object and a macro photographing function for photographing from close to the object, is provided with a variable filter inserted to an irradiation light path of a light emission section of the strobe light device and capable of limiting and adjusting an amount of transmitted light, and a filter control section variably controlling an amount of irradiated light to the object by controlling the amount of transmitted light of the variable filter at least at a time of photographing by the macro photographing function.

Further, in JP-A No. 7-209703, there is disclosed an art that can reduce a labor hour for adjusting an irradiation range of a light (corresponding to the strobe light described above). In this art, in a lighting device having a reflection surface covering a rear side and a side portion of a lamp, and a lamp power source connected to the lamp, there are provided with a liquid crystal light modulating sheet covering front sides of the lamp and the reflection surface, and a voltage source connected to transparent conductive layers provided in both surfaces of the sheet.

Further, in JP-A No. 7-168261, there is disclosed an art for obtaining a natural color image without providing a white balance circuit and a vertical edge sampling circuit. In this art, there are provided with a light emitting section having first and second luminous tubes capable of emitting strobe lights having different color temperatures, a monochrome liquid crystal filter arranged in front sides of the first and second luminous tubes and controlling an amount of transmitted light, a color measuring section for detecting color temperature of the surrounding light, and a control section changing the color temperature of the strobe light by controlling a density of the monochrome liquid crystal filter according to the color temperature, and controlling the color temperature of the light illuminating the object becomes substantially equal to a design value of a spectral sensitivity of an imaging element.

In many cases, the photographing device is provided with, in addition to the strobe light as described above, various light sources irradiating an auxiliary light toward an object at a time of photographing, such as a light source irradiating an assist light for an automatic focusing, or the like. Further, since these light sources are comparatively expensive and require a comparatively larger installation space, there is a high demand for utilizing the light sources as effectively as possible.

However, in the arts disclosed in the documents described above, although it is possible to preferably adjust the amount of light emission of the strobe light, an effective use of the light sources described above is not considered. Therefore, it is not necessarily possible to effectively utilize the light source.

### SUMMARY OF THE INVENTION

The present invention is made by taking the above matters into consideration, and provides an auxiliary light irradiating device for a photographing device which can effectively utilize a light source for irradiating an auxiliary light toward an object, a method of controlling the auxiliary light irradiating device, and a storage medium for storing a program thereof.

In accordance with a first aspect of the invention, there is provided an auxiliary light irradiating device for a photographing device including: a light source for irradiating an auxiliary light toward an object to be photographed; a liquid crystal panel provided in a light path of the auxiliary light from the light source toward the object, and configured to display an image at a predetermined resolution; an input section for inputting application information indicating an application of the liquid crystal panel; and a control section for controlling the liquid crystal panel so that a display image is changed according to the application indicated by the application information.

The auxiliary light irradiating device for the photographing device in accordance with the invention is structured such that the liquid crystal panel formed so as to be capable of displaying given image at the predetermined resolution is provided in the light path toward the object of the auxiliary light, which is emitted from the light source for irradiating the auxiliary light toward the object.

Here, in accordance with the invention, the application information indicating the application of the liquid crystal panel is input through the input section, and the liquid crystal panel is controlled by the control section in such a manner that the displayed image is changed according to the application indicated by the application information.

Thus, it is possible to effectively utilize the light source.

### BRIEF DESCRIPTION OF THE DRAWINGS

Exemplary embodiments of the present invention will be described in detail based on the following figures, wherein:

FIG. 1 is an overall view showing an external appearance of a digital camera in accordance with a first embodiment;

FIG. 2 is a block diagram showing a main structure of an electric system of the digital camera in accordance with the first embodiment;

FIG. 3 is a cross sectional side elevational view showing a structure of a strobe light section in accordance with the embodiments;

FIG. 4 is a flow chart showing a process flow of a liquid crystal control processing program in accordance with the first embodiment;

FIG. 5 is a flow chart showing a process flow of a remaining time display interrupt processing program in accordance with the first embodiment;

FIG. 6 is a flow chart showing a process of an AF lamp light emission interrupt processing program in accordance with the first embodiment;

FIG. 7 is a flow chart showing a process flow of a through image display interrupt processing program in accordance with the first embodiment;

FIG. 8 is a front view showing a display image of a color liquid crystal panel due to an execution of the remaining time display interrupt processing program in accordance with the first embodiment;

FIG. 9 is a front view showing a display image of the color liquid crystal panel on due to an execution of the AF lamp light emission interrupt processing program in accordance with the first embodiment;

FIG. 10 is a front view showing a display image of the color liquid crystal panel dues to an execution of the through image display interrupt processing program in accordance with the first embodiment;

FIG. 11 is an overall view showing an external appearance of a digital camera in accordance with a second embodiment;

FIG. 12 is a block diagram showing a main structure of an electric system of the digital camera in accordance with the second embodiment;

FIG. 13 is a flow chart showing a process flow of a high-speed AF mode processing program in accordance with the second embodiment;

FIGS. 14A to 14B are front views showing a display image of a monochrome liquid crystal panel due to an execution of the high-speed AF mode processing program in accordance with the second embodiment; and

FIG. 15 is a front view showing another example of the display image of the monochrome liquid crystal panel due to the execution of the high-speed AF mode processing program in accordance with the second embodiment.

### DETAILED DESCRIPTION OF THE INVENTION

A description will be given below in detail of embodiments in accordance with the present invention with reference to the accompanying drawings. In this case, the description is given in a case that the invention is applied to a digital electronic still camera (hereinafter, refer to as “digital camera”) executing a photographing of a still image.

### First Embodiment

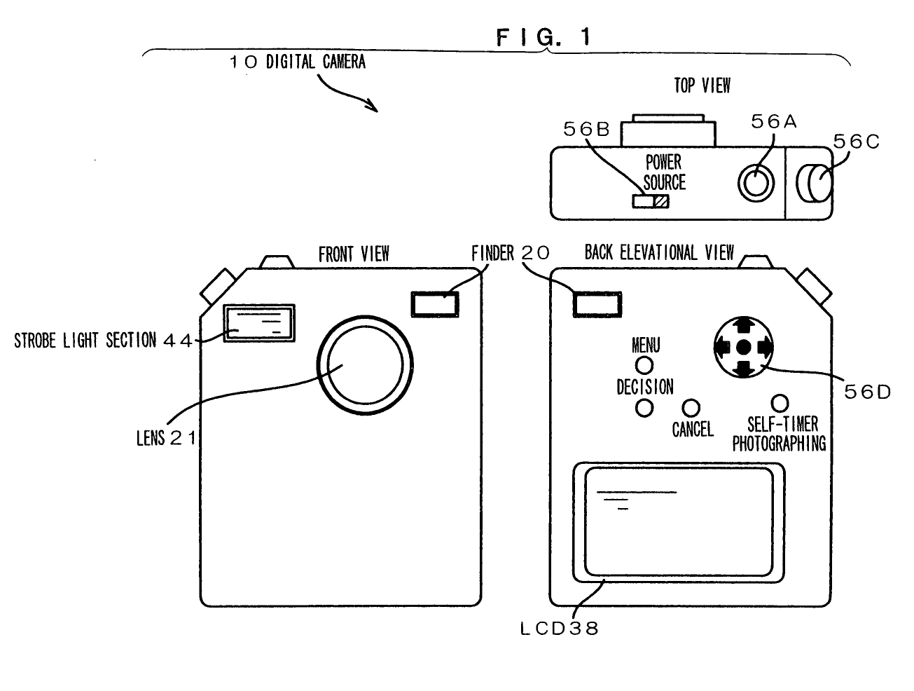

First, with reference to FIG. 1, a configuration of a digital camera 10 according to a first embodiment is described with respect to the appearance thereof.

In a front side of the digital camera 10, a lens 21 for image forming an object image, a strobe light section 44 emitting a light (a photographing auxiliary light) irradiated to the object as occasion demands at a time of photographing, and a finder 20 used for determining a image composition of the object to be photographed are provided. Further, in an upper surface of the digital camera 10, there are provided with a release switch (a so-called shutter) 56A which is operated to be pressed at a time of executing the photographing, a power source switch 56B and a mode-switching switch 56C.

The release switch 56A of the digital camera 10 according to the present embodiment is structured so that two-stage pressing operations can be detected including: a state where the release switch 56A is pressed to a half-way position (hereinafter referred to as a “half-pressed state”); and a state where the release switch 56A is pressed beyond the a half-way position to a final position (hereinafter referred to as a “fully pressed state”).

In the digital camera 10, as the release switch 56A is pressed to the half-pressed state, an AE (Automatic Exposure) function is actuated to set exposure conditions (shutter speed, diaphragm conditions), and then, an AF (Auto Focus) function is actuated for focusing control. Subsequently, as the release switch 56A is pressed to the fully pressed state, exposure (photographing) is carried out.

The mode-switching switch 56C is rotated by a user to set the digital camera 10 in one of a photographing mode for photographing, or a replay mode for displaying object images on an LCD 38 (described later).

The digital camera 10 further includes, on a back surface thereof, an eye piece of the finder 20, the liquid crystal display (hereinafter referred to as “LCD”) 38 for displaying images of photographed object and/or object to be photographed, a menu screen, and the like, and a cross-shaped cursor switch 56D. The cross-shaped cursor switch 56D includes four arrow keys indicating four directions (upward, downward, rightward and leftward) of movement within a display area of the LCD 38.

Further, in a back side of the digital camera 10, there are provided a menu switch which is operated to be pressed at a time of displaying a menu screen in the LCD 38, a decision switch operated so as to be pressed at a time of fixing an operation content set until that time, a cancellation switch which is operated to be pressed at a time of canceling the last operation content, and a self-timer photographing switch which is operated to be pressed at a time of executing a self-timer photographing.

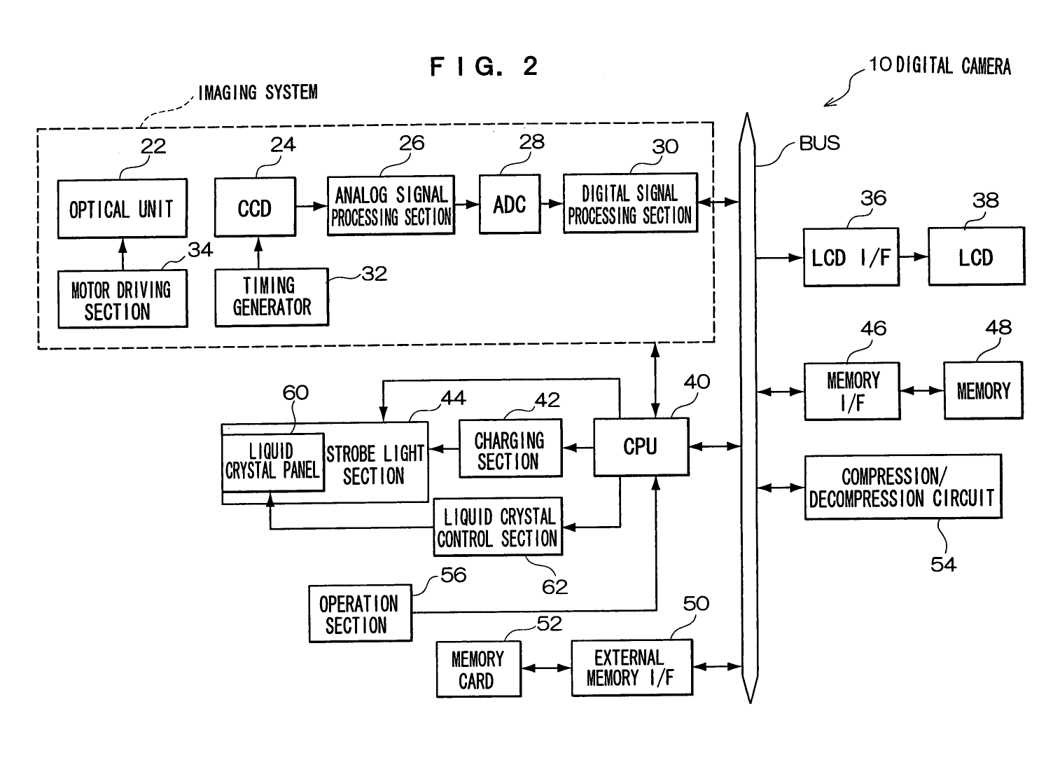

Next, with reference to FIG. 2, the main structure of an electric system of the digital camera 10 according to this embodiment is described.

The digital camera 10 includes an optical unit 22 including the lens 21, a charge-coupled device (hereinafter referred to as a “CCD”) 24 disposed behind the lens 21 along an optical axis, and an analog signal processing section 26 for performing various types of analog signal processing on inputted analog signals.

The digital camera 10 further includes an analog/digital converter (hereinafter referred to as an “ADC”) 28 for converting inputted analog signals into digital data, and a digital signal processing section 30 for performing various types of digital signal processing on inputted digital data.

The digital signal processing section 30 includes a line buffer having a predetermined capacity, and controls storage of the inputted digital data directly in predetermined areas of a memory 48 (described later).

An output terminal of the CCD 24 is connected to an input terminal of the analog signal processing section 26, an output terminal of the analog signal processing section 26 is connected to an input terminal of the ADC 28, and an output terminal of the ADC 28 is connected to an input terminal of the digital signal processing section 30. Therefore, an analog signal representing an object image outputted from the CCD 24 is subjected to predetermined analog signal processing performed by the analog signal processing section 26, converted into digital image data by the ADC 28, and then, is inputted to the digital signal processing section 30.

The digital camera 10 further includes: an LCD interface 36 for generating and supplying signals to the LCD 38 for displaying object images, a menu screen, and the like on the LCD 38; a CPU (central processing unit) 40 for controlling overall operation of the digital camera 10; a memory 48 for temporarily storing digital image data acquired through photographing, and the like; and a memory interface 46 for controlling access to the memory 48.

In addition, the digital camera 10 includes an external memory interface 50 for enabling access to a portable memory card 52 from the digital camera 10, and a compression/decompression circuit 54 for compressing and decompressing digital image data.

In the digital camera 10 in accordance with the present embodiment, a flash memory is used as the memory 48, and a smart media (trade mark) is used as the memory card 52.

The digital signal processing section 30, the LCD interface 36, the CPU 40, the memory interface 46, the external memory interface 50 and the compression/decompression circuit 54 are connected to each other via a system bus BUS. Accordingly, the CPU 40 can control operations of the digital signal processing section 30 and the compression/decompression circuit 54, display various information to the LCD 38 via the LCD interface 36, and access to the memory 48 and the memory card 52 via the memory interface 46 or the external memory interface 50.

The digital camera 10 includes a timing generator 32 for generating and supplying timing signals to the CCD 24 mainly for driving the CCD 24. Drive of the CCD 24 is controlled by the CPU 40 via the timing generator 32.

The digital camera 10 further includes a motor driving section 34. The CPU 40 also controls, via the motor driving section 34, driving of a focus adjusting motor, a zooming motor and a diaphragm driving motor (which are not shown) provided in the optical unit 22.

That is, the lens 21 according to this embodiment includes plural lenses and is formed as a zoom lens that allows alteration of a focal distance (scaling), and is provided with a lens driving mechanism (not shown). The focus adjusting motor, the zooming motor and the diaphragm driving motor are included in the lens driving mechanism, and these motors are respectively driven by driving signals supplied from the motor driving section 34 controlled by the CPU 40.

Further, various switches such as the release switch 56A, the power switch 56B, the mode-switching switch 56C, the cross-shaped cursor switch 56D, and the menu switch (which are collectively referred to as an “operation section 56” in FIG. 2) are connected to the CPU 40, so that the CPU 40 can always be aware of the operation statuses of the operation section 56.

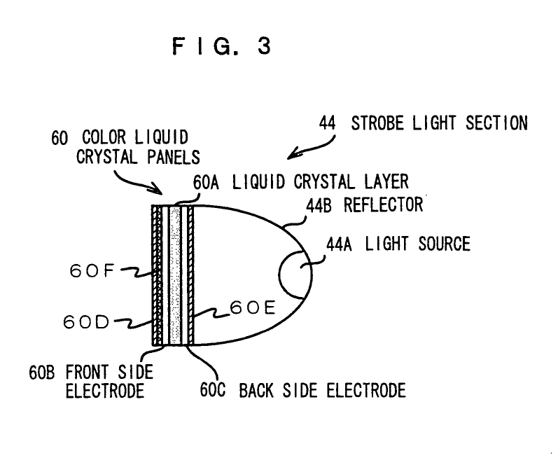

Furthermore, in the digital camera 10, there is provided with a charging section 42 interposed between the strobe light section 44 and the CPU 40, and charging an electric power for lighting a light source 44A (refer to FIG. 3), which is provided in the strobe light section 44 and described below, on the basis of the control of the CPU 40. Further, the strobe light section 44 is also connected to the CPU 40, and the light emission of the light source 44A of the strobe light section 44 is controlled by the CPU 40.

On the other hand, the strobe light section 44 according to the present embodiment is provided with a color liquid crystal panel 60 structured so as to be capable of displaying a given image at a predetermined resolution, and is provided with a liquid crystal control section 62 interposed between the color liquid crystal panel 60 and the CPU 40. The setting of the display image by the color liquid crystal panel 60 is executed by the CPU 40 via the liquid crystal control section 62.

Next, a description will be given for a structure of the strobe light section 44 with reference to FIG. 3.

As shown in the drawing, the strobe light section 44 according to the present embodiment is provided with the light source 44A and a reflector 44B. The light source 44A is constituted by a light emitting diode (LED) which serves to irradiate a light (photographing auxiliary light) to the object. The reflector 44B serves to reflect and focus (condense) the photographing auxiliary light emitted from the light source 44A.

The reflector 44B according to the present embodiment is formed in a semi-elliptic shape in cross-sectional view, in which an opening portion (an edge portion) is directed to a front side of the digital camera 10, and the light source 44A is provided in a deepest portion of an inner surface of the reflector 44B. Accordingly, the photographing auxiliary light emitted from the light source 44A is irradiated toward an object direction in a state in which the light reflected by the reflector 44B is included.

On the other hand, the color liquid crystal panel 60 described above is provided in the opening portion of the reflector 44B, so that the photographing auxiliary light emitted from the light source 44A including the light reflected from the reflector 44B transmits through the color liquid crystal panel 60.

As shown in FIG. 3, the color liquid crystal panel 60 according to the present embodiment is provided with a liquid crystal layer 60A in a center portion thereof. Further, a surface electrode 60B, a color filter 60F and a polarizing plate 60D are provided on one side of the liquid crystal layer 60A, and a back surface electrode 60C and a polarizing plate 60E are provided on the other side, respectively in a laminated state. In this case, although an orientation film, a glass substrate and the like are additionally laminated on the color liquid crystal panel 60, since structures of these elements are conventionally known, further descriptions thereof will be omitted.

Next, overall operation of the digital camera 10 according to this embodiment during photographing is briefly described.

First, the CCD 24 captures an image through the optical unit 22, and sequentially outputs analog signals representing an object image for each of R (red), G (green) and B (blue) components to the analog signal processing section 26. The analog signal processing section 26 performs analog signal processing such as Correlated Double Sampling (CDS) on the analog signals inputted from the CCD 24, and then, sequentially outputs the processed analog signals to the ADC 28.

The ADC 28 converts the analog signals for R, G and B components inputted from the analog signal processing section 26 into 12-bit R, G and B signals (digital image data), and then, sequentially outputs the converted signals (digital image data) to the digital signal processing section 30. The digital signal processing section 30 accumulates the digital image data sequentially inputted from the ADC 28 in the line buffer thereof, and directly stores the digital image data in a predetermined area of the memory 48 for temporary storage.

The digital image data stored in a predetermined area of the memory 48 is read by the digital signal processing section 30 in response to the control by the CPU 40. An 8-bit digital image data is generated by performing white balancing which is executed by multiplying the read digital image data by a digital gain each for R, G and B according to a predetermined physical amount, and executing a gamma correction process and a sharpness process.

Then, the digital signal processing section 30 applies a YC signal process to the generated 8-bit digital image data so as to generate a brightness signal Y and chroma signals Cr and Cb (hereinafter referred to as “YC signal”), and stores the YC signal in a different area from the predetermined area.

It should be noted that the LCD 38 is formed to be usable as a finder by displaying a motion image (a through image) that is continuously captured by the CCD 24. When the LCD 38 is used as a finder, the generated YC signals are sequentially outputted to the LCD 38 via the LCD interface 36. In this manner, a through image is displayed on the LCD 38.

Here, after the AE function is activated as described above at a time when the release switch 56A is set to the half-pushed state by the user and the exposure state is set, the AF function is activated and a focusing control is executed. Thereafter, at a time when the release switch 56A is set to the full-pushed stat, the YC signal stored in the memory 48 at that time is compressed in a predetermined compression format (JPEG format in the present embodiment) by the compression/decompression circuit 54 and is thereafter recorded as a electric file (an image file) in the memory card 52 via the external memory interface 50.

A liquid crystal control function for controlling the color liquid crystal panel 60 is implemented to the digital camera 10 according to the present embodiment so that the display image is changed according to an application indicated by a preset operation mode.

In the digital camera 10, as the operation mode described above, there are prepared three kinds of modes of: a remaining time display mode that controls the color liquid crystal panel 60 so as to display a remaining time when executing the self-timer photographing, an AF lamp mode that controls the color liquid crystal panel 60 so as to execute an irradiation of the auxiliary light for an automatic focusing control, and a mirror photographing mode that controls the color liquid crystal panel 60 so as to display the photographing object when photographing a photographer him/herself.

Here, the digital camera 10 according to the present embodiment is structured such that the remaining time display mode, the AF lamp mode and the mirror photographing mode are set by setting on the menu screen by operation to the operation section 56. However, the structure is not limited to this. For example, a dedicated switch for setting the operation modes in advance can be provided, and the setting can be executed by operations applied to the switch.

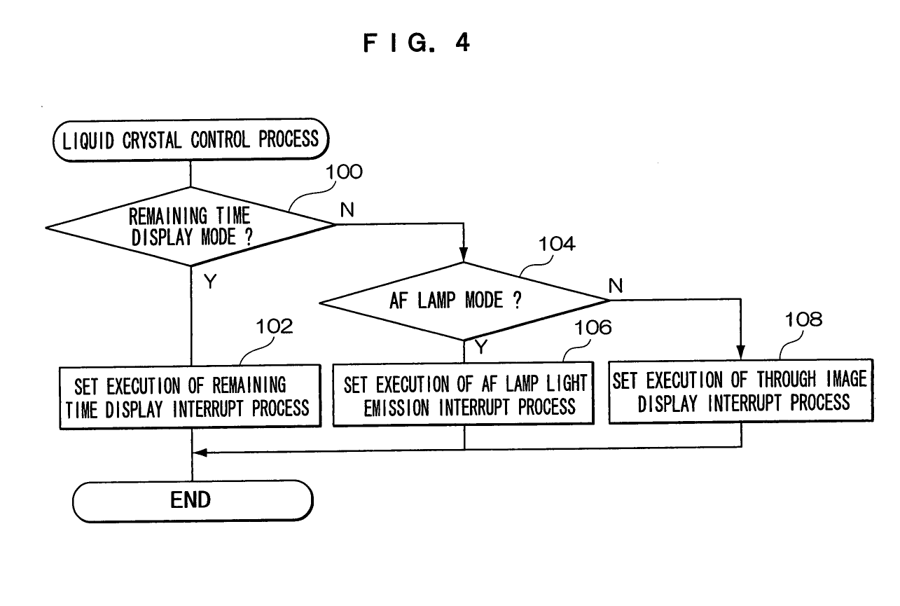

Next, a description will be given of an operation of the digital camera 10 when executing the liquid crystal control function, with reference to FIG. 4. FIG. 4 is a flow chart showing a process flow of a liquid crystal control processing program executed by the CPU 40 of the digital camera 10 at a time when the user sets any one of the operation modes out of the remaining time display mode, the AF lamp mode and the mirror photographing mode. The program is stored in advance in a predetermined area of the memory 48 (that is, a storage medium).

First, in step 100, it is determined whether or not the operation mode set by the user is the remaining time display mode, and if the determination is affirmative, the process proceeds to step 102. In step 102, a remaining time display interrupt processing program described below is set to be executed as an interrupt processing when the self-timer photographing is executed and the release switch 56A is set to the full-push state, and thereafter the liquid crystal control processing program is terminated.

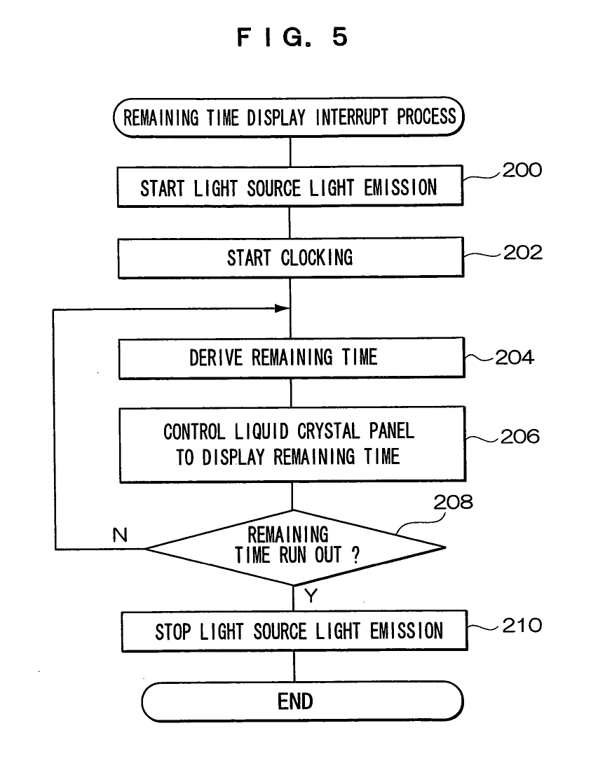

Here, a description will be given below of the remaining time display interrupt processing program that is performed when the self-timer photographing is executed, and the release switch 56A is set to the full-push state, with reference to FIG. 5.

In step 200 of the drawing, light emission by the light source 44A at a predetermined brightness is initiated, and in the next step 202, clocking by a timer (not shown) built into the CPU 40 is started. In the next step 204, the time remaining until the photographing is derived by subtracting the time clocked by the timer from a time (for example, 8 seconds) set in advance, which is the time from when the release switch 56A is set to the full-push state at the time of executing the timer photographing, until the time the photographing is actually executed.

In the next step 206, the color liquid crystal panel 60 is controlled via the liquid crystal control section 62 so as to display the remaining time derived in step 204 described above. In the next step 208, it is determined whether or not the remaining time has run out (becomes zero). When the determination is negative, the process returns to step 204. When the determination becomes affirmative, the process proceeds to step 210 and stops the light emission of the light source 44A, and thereafter the remaining time display interrupt processing program is terminated.

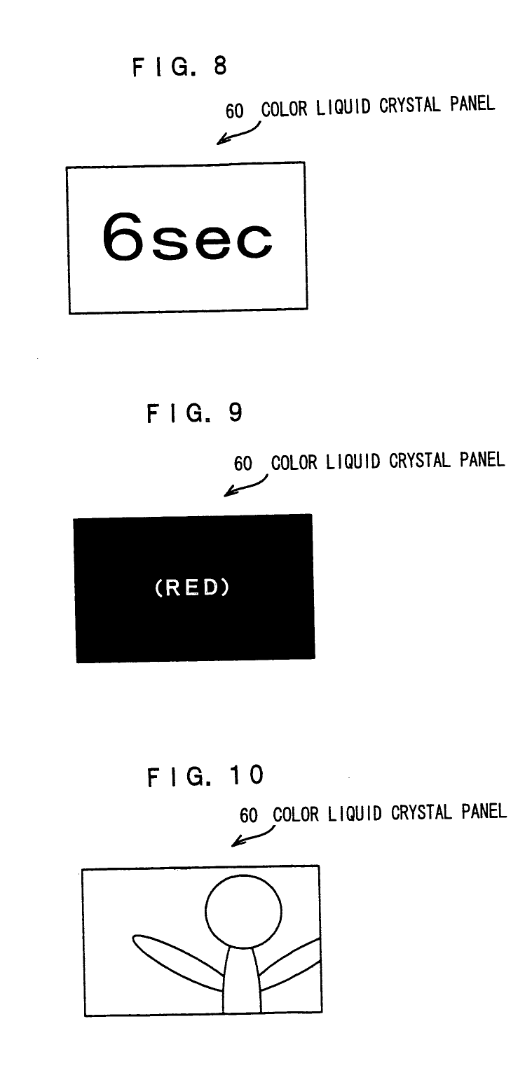

On the basis of the execution of the remaining time display interrupt processing program as described above, the time until the photographing is actually executed can be displayed on the color liquid crystal panel 60, as shown in FIG. 8 as one example, and thus it is possible to improve the operability of the digital camera 10.

Further, it is possible to employ embodiments for changing the color of the transmitted light by the color liquid crystal panel 60 according to the remaining time, or changing the brightness of the light emission of the light source 44A. In this way, it is possible to call the photographed person's attention to the remaining time.

On the other hand, when the determination is negative in step 100 of the liquid crystal control processing program (refer to FIG. 4), the process proceeds to step 104, and determines whether or not the operation mode set by the user is the AF lamp mode. If the determination is affirmative, the process proceeds to step 106, an AF lamp light emission interrupt processing program is set to be executed as the interrupt process when the AF function is activated, and thereafter the liquid crystal control processing program is terminated.

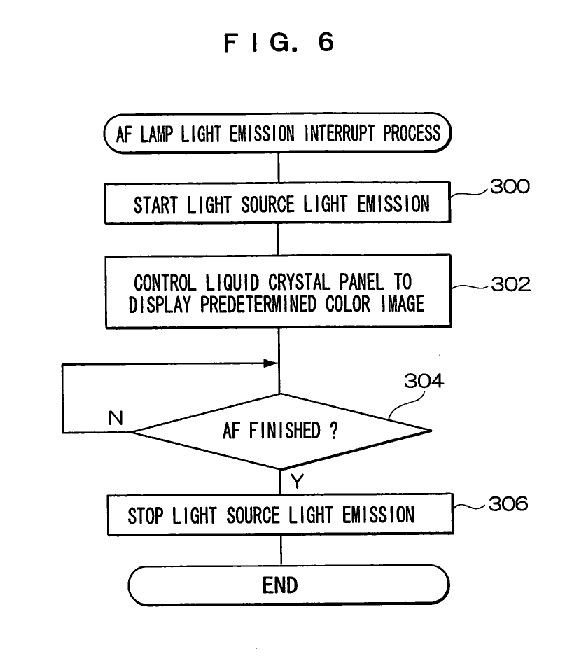

Here, description will be given below of the AF lamp light emission interrupt processing program executed when the AF function is activated, with reference to FIG. 6.

In step 300 in the drawing, light emission at a predetermined brightness by the light source 44A for the AF function is initiated. In the next step 302, the color liquid crystal panel 60 is controlled via the liquid crystal control section 62 so as to display, on the entire surface, an image of a color (a red color in this case) which is predetermined as a color of an auxiliary light at a time of activating the AF function. In the next step 304, the process waits for the end of the AF function. In the next step 306, the light emission of the light source 44A is stopped and the AF lamp light emission interrupt processing program is terminated.

On the basis of the execution of the AF lamp light emission interrupt processing program described above, it is possible to set the color liquid crystal panel 60 to the predetermined color (the red color in this case), as shown in FIG. 9 as one example. Thereby, it is possible to utilize the red light irradiated to an object to be photographed by the AF function. Accordingly, there is no need to arrange a tally lamp for the AF function, and it is possible to achieve cost reduction and downsizing.

In this case, it can be configured such that the transmitted light is condensed by controlling a refraction factor of the color liquid crystal panel 60 so as to be higher at a center portion of the display area of the color liquid crystal panel 60 when displaying the image of the predetermined color across the color liquid crystal panel 60. Accordingly, it is possible to increase the execution speed of the AF function.

On the other hand, when the determination is negative in step 104 of the liquid crystal control processing program (refer to FIG. 4), it is considered that the operation mode set by the user is the mirror photographing mode, and the process proceeds to step 108. In step 108, a through image display interrupt processing program, which is described below, is set to be executed as an interrupt processing immediately after the execution of the liquid crystal control processing program is completed, and thereafter the liquid crystal control processing program is terminated.

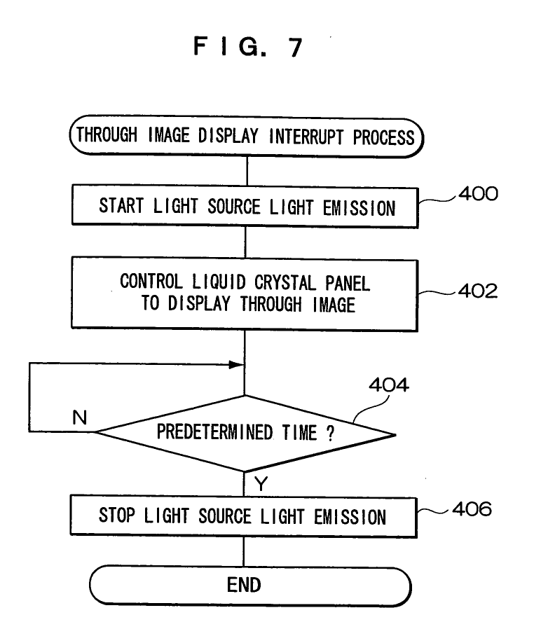

Here, description will be given of the through image display interrupt processing program that is executed immediately after completion of the execution of the liquid crystal control processing program, with reference to FIG. 7.

In step 400 in the drawing, light emission by the light source 44A, at a predetermined brightness for displaying a through image, is initiated. In the next step 402, the color liquid crystal panel 60 is controlled via the liquid crystal control section 62 so as to display the through image. In the next step 404, the process waits for a time which is predetermined as a time of finishing the mirror photographing mode (in this case, a time at which the release switch 56A is set to the full-push state). In the next step 406, the light emission of the light source 44A is stopped, and thereafter the through image display interrupt processing program is terminated.

On the basis of the execution of the through image display interrupt processing program described above, as shown in FIG. 10 as one example, it is possible to display the through image on the color liquid crystal panel 60, and it is possible to improve the operability of the digital camera 10.

As described above in detail, in accordance with the present embodiment, the liquid crystal panel (the color liquid crystal panel 60, in this case), which is provided in the light path toward an object to be photographed of the auxiliary light from the light source (the light source 44A, in this case) that irradiates the auxiliary light toward the object to be photographed, and which is structured so as to be capable of displaying a given image at a predetermined resolution, is controlled so that the display image is changed so as to correspond to the application indicated by the input application information. Accordingly, it is possible to effectively utilize the light source as described above.

Further, in the present embodiment, since the light source described above is a light emitting diode, it is possible to easily control the light emission of the light source.

Further, in the present embodiment, the light source is a light source for the strobe light, and the application described above can be selected from any one of display of the remaining time when using self-timer photographing, irradiation of the auxiliary light for the automatic focusing control, and display of the object to be photographed when photographing the photographer. When the selected application is the display of the remaining time, the liquid crystal panel is controlled so that the remaining time is displayed as the display image. When the selected application is the irradiation of the auxiliary light for the automatic focusing control, the liquid crystal panel is controlled so that an image of a color predetermined as the color of the auxiliary light is displayed as the display image. When the selected application is the display of the object to be photographed, the liquid crystal panel is controlled so that the object to be photographed is displayed as the display image. Accordingly, when the application is the display of the remaining time, it is possible to improve the operability of the digital camera 10. When the application is the irradiation of the auxiliary light for the automatic focusing control, there is no need to provide a tally lamp for the AF function, and it is possible to achieve cost reduction and downsizing of the digital camera 10. When the application is the display of the object to be photographed, it is also possible to improve the operability of the digital camera 10.

Further, in the present embodiment, since the light source is controlled so that the light emission state is changed to correspond to the application indicated by the application information, it is possible to effectively utilize the light source more suitably.

Furthermore, in the present embodiment, since the liquid crystal panel is a color liquid crystal panel, it is possible to more effectively utilize the light source in comparison to a case when a monochrome liquid crystal panel is employed as the liquid crystal panel.

Here, description has been given of a case in which, when executing the self-timer photographing, the remaining time until the time of actual photographing is displayed by the color liquid crystal panel 60. However, the invention is not limited to this. For example, substantially in the same manner as the operation when the AF lamp mode is set, the color liquid crystal panel 60 may be controlled so as to display an image of a color (for example, a red color) which is predetermined as a color for indicating the actual photographing time when executing the self-timer photographing. Further, the photographing time can be indicated by controlling the light emission state of the light source 44A so as to increase a flash cycle as the photographing time approaches. In this case, it is also possible to improve the operability of the digital camera 10.

Further, in the embodiment, description has been given of a case in which the digital camera 10 is structured to be capable of executing all the modes including the remaining time display mode, the AF lamp mode and the mirror photographing mode. However, the invention is not limited to this. It can be configured to be capable of executing any one or two of these modes. It is also possible to obtain the same effect as that of the present embodiment in such a case.

Furthermore, in the present embodiment, description has been given of a case in which the color liquid crystal panel 60 is employed as the liquid crystal panel according to the invention. However, the invention is not limited to this. The structure may be configured to employ a monochrome liquid crystal panel. In such a case, since a monochrome liquid crystal panel is inexpensive in comparison with a color liquid crystal panel, it is possible to achieve the device of the present invention at a low cost.

### Second Embodiment

In the first embodiment described above, the description is given in an example that the light source for the strobe light is employed as the light source according to the present invention. In the second embodiment, a description will be given in the case that the light source for the AF function is employed as the light source according to the present invention.

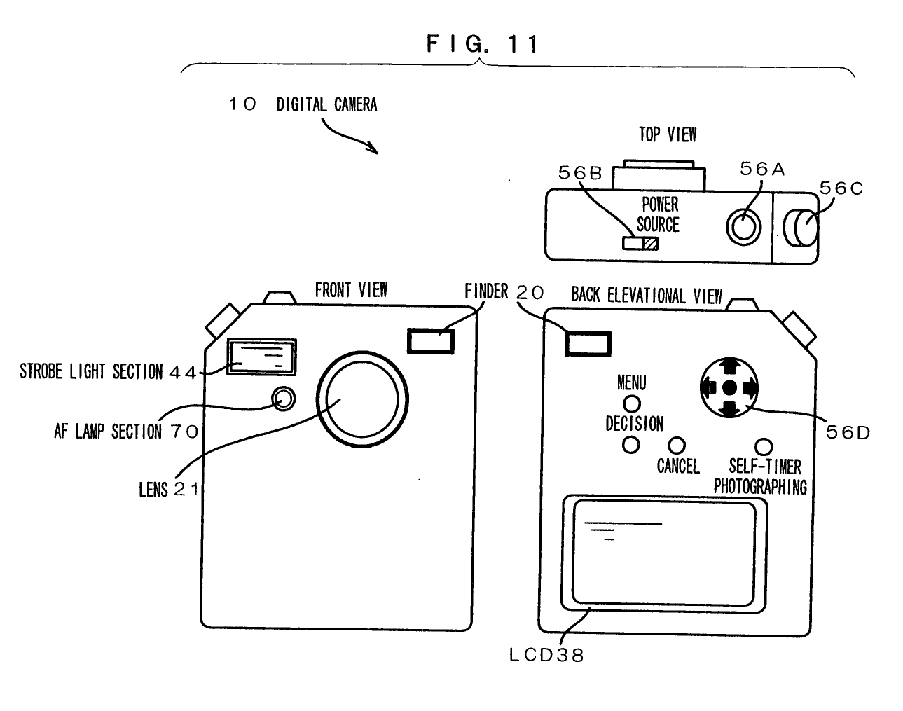

First, a description on a structure on of external appearance of a digital camera 10′ in accordance with the second embodiment will be given with reference to FIG. 11. Here, the same reference numerals as those of FIG. 1 are attached to the same constituting elements in FIG. 11 as those of FIG. 1, and a description thereof will be omitted.

As shown in the drawing, the digital camera 10′ in accordance with the second embodiment is different from the digital camera 10 in accordance with the first embodiment only in that an AF lamp section 70 for irradiating an auxiliary light for an automatic focusing control to an object to be photographed is provided in the front side thereof.

Next, a description on a main structure of an electric system of the digital camera 10′ in accordance with the second embodiment will be given with reference to FIG. 12. Here, the same reference numerals as those of FIG. 2 are attached to the same constituting elements in FIG. 12 as those of FIG. 2, and a description thereof will be omitted.

As shown in the drawing, the digital camera 10′ in accordance with the second embodiment is different from the digital camera 10 in accordance with the first embodiment described above mainly in that the AF lamp section 70 is connected to the CPU 40.

As shown in the drawing, the AF lamp section 70 is provided with a light source 72 constituted by the LED, and is provided with a monochrome liquid crystal panel 74 structured so as to be capable of displaying a given image at a predetermined resolution. The auxiliary light for the AF function emitted from the light source 72 is configured to transmit through the monochrome liquid crystal panel 74. The structure of the monochrome liquid crystal panel 74 is approximately the same structure as the color liquid crystal panel 60 described in the first embodiment, except for the color filter 60F is not provided. Since the structure is conventionally known, a further description of the monochrome liquid crystal panel 74 is omitted.

The digital camera 10′ is provided with a liquid crystal control section 76 interposed between the monochrome liquid crystal panel 74 and the CPU 40, and setting of a display image by the monochrome liquid crystal panel 74 is executed by the CPU 40 via the liquid crystal control section 76.

In this case, the digital camera 10′ according to the second embodiment is implemented with a high-speed AF mode capable of increasing the automatic focusing speed, and a macro photographing mode capable of appropriately executing a close-up photographing.

In the digital camera 10′ in accordance with the present embodiment, it is structured such that the setting of the high-speed AF mode and the macro photographing mode is performed by setting on the menu screen by operating on the operation section 56. However, the structure is not limited to this. For example, a dedicated switch for setting the high-speed AF mode and the macro photographing mode can be provided in advance, and the mode can be set by operating on the switch.

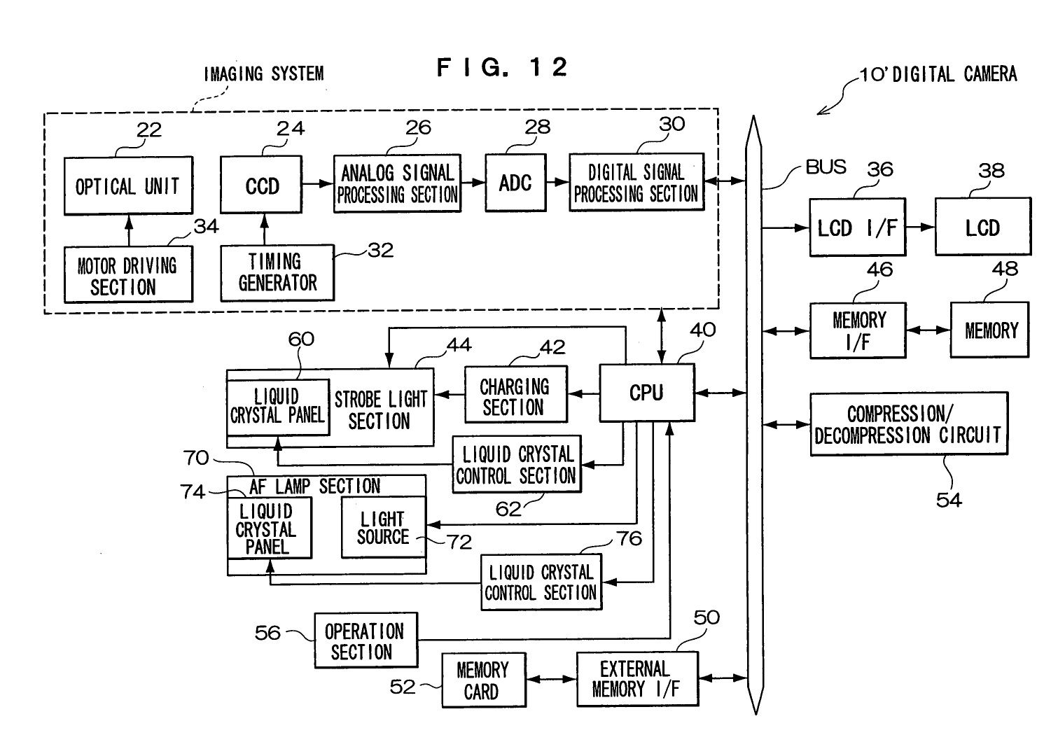

Next, a description of an operation of the digital camera 10′ when executing the high-speed AF mode will be given with reference to FIG. 13. FIG. 13 is a flow chart showing a process flow of a high-speed AF mode processing program executed by the CPU 40 of the digital camera 10′ according to the second embodiment, when the AF function is activated in a state in which the high-speed AF mode is set. The program is stored in advance in a predetermined area of the memory 48.

First, in step 500, light emission, in a brightness which is predetermined for the AF function, of the light source 72 is initiated. In the next step 502, an image data indicating a predetermined image that can increase the automatic focusing speed for the high-speed AF mode is acquired. In this case, in the digital camera 10′ according to the embodiment, an image indicating a predetermined character (“A” in this case) is employed as the image, and image data indicating this image is stored in advance in a predetermined area of the memory 48. Accordingly, in step 502, the image date is acquired by reading the data from the memory 48.

In the next step 504, it is determined whether or not the macro photographing mode is set, and if the determination is negative, the process proceeds to step 506. In step 506, the image data for the high-speed AF mode acquired by the process in step 502 is converted so that the image indicated by the image data is enlarged at a predetermined magnification (in this case, 3 times larger in both of a horizontal direction and a vertical direction), and thereafter the process proceeds to step 508. If the determination is affirmative in step 504, the process proceeds to step 508 without executing the process in step 506.

In step 508, the monochrome liquid crystal panel 74 is controlled via the liquid crystal control section 76 so as to display the image data for the high-speed AF mode which is obtained by the process described above. In the next step 510, the process waits for the end of the AF function. In the next step 512, the light emission of the light source 72 is stopped, and thereafter the high-speed AF mode processing program is terminated.

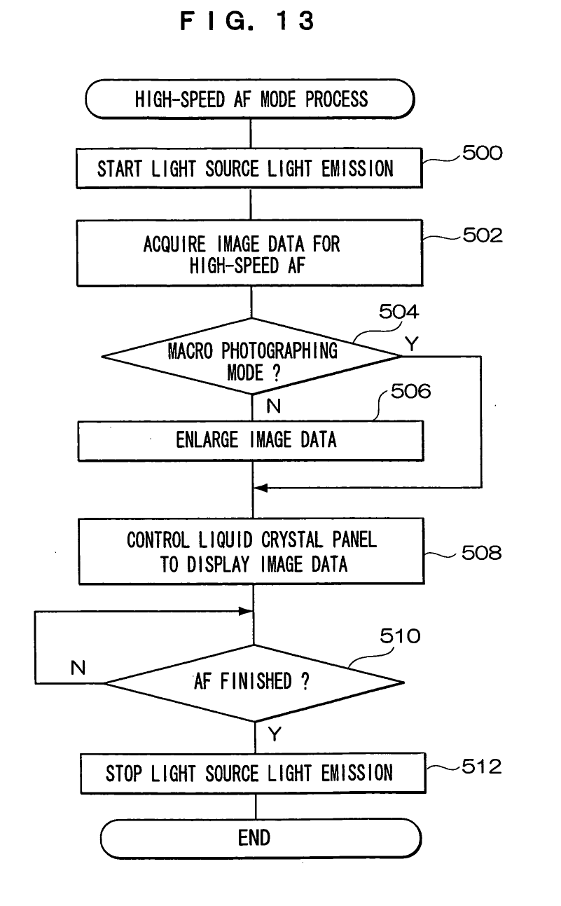

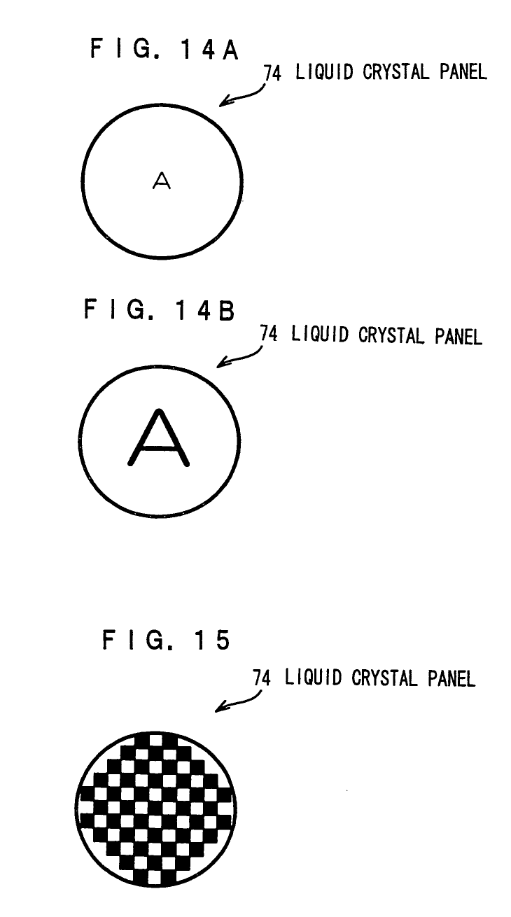

On the basis of the execution of the high-speed AF mode processing program described above, as shown in FIGS. 14A to 14B as one example, when the macro photographing mode is set, the image for the high-speed AF mode is displayed on the monochrome liquid crystal panel 74 at a smaller size (see FIG. 14A) in comparison with the normal photographing time, and when the normal photographing is performed, the image for the high-speed AF mode is displayed on the monochrome liquid crystal panel 74 at a larger size (see FIG. 14B) in comparison with the case that the macro photographing mode is set. Accordingly, it is possible to obtain a preferable image size corresponding to a distance to an object to be photographed, and it is possible to more suitably execute the automatic focusing control.

As described in detail above, according to the present embodiment, a liquid crystal panel (the monochrome liquid crystal panel 74 in this case) which is provided in the light path, toward an object to be photographed, of the auxiliary light by the light source (the light source 72 in this case) for irradiating the auxiliary light toward the object, and structured so as to be capable of displaying an given image at a predetermined resolution, is controlled such that the display image is changed so as to correspond to the application indicated by the input application information. Accordingly, it is possible to effectively utilize the light source.

Further, in the present embodiment, since the light source is constituted by the light emitting diode, it is possible to easily control the light emission state of the light source.

Furthermore, in the present embodiment, the light source is constituted by the light source irradiating the auxiliary light for the automatic focusing control, the application is to increasing the automatic focusing speed, and the liquid crystal panel is controlled so as to display a predetermined image for increasing the automatic focusing speed. Accordingly, it is possible to increase the automatic focusing speed.

Specifically, in the present embodiment, the liquid crystal panel is controlled so as to display the image larger as the distance to an object increases. Accordingly, it is possible to more suitably execute the automatic focusing control.

Further, in the present embodiment, the light source is controlled such that the light emission state is changed so as to correspond to the application indicated by the application information. Accordingly, it is possible to effectively utilize the light source more suitably.

Furthermore, in the present embodiment, a monochrome liquid crystal panel is employed as the liquid crystal panel. Accordingly, in comparison with the case that a color liquid crystal panel is employed as the liquid crystal panel, it is possible to achieve the device of the present invention at a lower cost.

In the present embodiment, the description in a case that the image indicating the character shown as one example in FIGS. 14A to 14B is employed as the image capable of increasing the automatic focusing speed is given. However, the invention is not limited to this. For example, as shown in FIG. 15, a pattern image which have space frequency predetermined for increasing the automatic focusing speed can be employed, so as to correspond to a characteristic of the CCD 24 or the like. Also in this case, it is possible to obtain the same effect as that of the present embodiment.

As described above, the invention can be achieved as an auxiliary light irradiating device for a photographing device including: a light source for irradiating an auxiliary light toward an object to be photographed; a liquid crystal panel provided in a light path of the auxiliary light from the light source toward the object, and configured to display an image at a predetermined resolution; an input section for inputting application information indicating an application of the liquid crystal panel; and a control section for controlling the liquid crystal panel so that a display image is changed according to the application indicated by the application information.

In the present invention, the light source may be constituted by the light emitting diode.

Further, the invention can be structured such that the light source includes a light source for a strobe light, the application is selected from any one of (a) display of remaining time during self-timer photographing, (b) presentation of a photographing timing during the self-timer photographing, (c) irradiation of the auxiliary light for an automatic focusing control, and (d) display of the object to be photographed when photographing a photographer, and the control section controls the liquid crystal panel so as to (a) display the remaining time as the display image when the display of the remaining time is selected as the application, (b) display, as the display image, an image of a color predetermined as a color indicating the photographing timing when the presentation of the photographing timing is selected as the application, (c) display, as the display image, an image of a color predetermined as a color of the auxiliary light when the irradiation of the auxiliary light for the automatic focusing control is selected as the application, and (d) display the object to be photographed as the display image when the display of the object to be photographed is selected as the application.

Further, the invention can be structured such that the light source includes a light source for irradiating an auxiliary light for an automatic focusing control, the input application is for increasing an automatic focusing speed, and the control section controls the liquid crystal panel so as to display as the display image a predetermined image for increasing the automatic focusing speed.

Particularly, the invention can be structured such that the control section controls the liquid crystal panel so as to display the image such that the size of the image displayed is increased as the distance to the object increases. In the photographing device in recent years, a macro photographing mode which can be set when performing a close photographing is implemented in many cases. Accordingly, it is possible to achieve the device in accordance with the present invention at a low cost and a saved space, by determining that the distance to the object is near when the macro photographing mode is set, and the distance to the object is far when the macro photographing mode is not set.

Further, the invention can be structured such that the control section controls the light source so that a light emitting state is changed according to the application indicated by the application information.

The liquid crystal panel of the invention can be constituted by a color liquid crystal panel.

Further, the invention can be achieved as a method of controlling the auxiliary light irradiating device, and a storage medium storing a program for controlling the auxiliary light irradiating device.

In each of the embodiments described above, the description is given as to the case that LED is employed as the light source of the invention. However, the present invention is not limited to this. It is possible to employ a configuration having other kind of light source. Also in this case, it is possible to obtain the same effects as those in each of the present embodiments.

The structures of the digital cameras 10 and 10′ according to the embodiments described above (refer to FIGS. 1 to 3, 11 and 12) are shown as examples, and it should be appreciated that the structure can be appropriately modified within the scope of the invention.

Further, the flows of the processes of the various processing programs described in the present embodiments (refer to FIGS. 4 to 7 and 13) are also shown as examples, and it should be appreciated that it is possible to change the processing order of the respective steps and the processing contents, delete unnecessary steps, adding new steps and the like, within the scope of the invention.

Similarly, the display states of the images by the liquid crystal panel described in the present embodiments described above (refer to FIGS. 8 to 10, 14A to 14B and 15) are shown as examples, and it should be appreciated that the display states is possible to be appropriately changed within the scope of the invention.

Furthermore, in each of the present embodiments, the description is given as to the case that the invention is applied to the digital camera. However, it should be appreciated that the present invention can be applied to any information device as far as it has a photographing function, such as a PDA, a portable telephone, or the like.

What is claimed is:

1. An auxiliary light irradiating device for a photographing device comprising:
a light source for irradiating an auxiliary light toward an object to be photographed;
a liquid crystal panel provided in a light path of the auxiliary light from the light source toward the object, and configured to display an image at a predetermined resolution;
an input section for inputting application information indicating an application of the liquid crystal panel; and
a control section for controlling the liquid crystal panel so that a display image is changed according to the application indicated by the application information.

2. An auxiliary light irradiating device for a photographing device according to claim 1, wherein the light source comprises a light emitting diode.

3. An auxiliary light irradiating device for a photographing device according to claim 1, wherein the light source comprises a light source for a strobe light,
the application is selected from any one of (a) display of remaining time during self-timer photographing, (b) presentation of a photographing timing during the self-timer photographing, (c) irradiation of the auxiliary light [assist light?] for an automatic focusing control, and (d) display of the object to be photographed when photographing a photographer, and
the control section controls the liquid crystal panel so as to
(a) display the remaining time as the display image when the display of the remaining time is selected as the application,
(b) display, as the display image, an image of a color predetermined as a color indicating the photographing timing when the presentation of the photographing timing is selected as the application,
(c) display, as the display image, an image of a color predetermined as a color of the auxiliary light when the irradiation of the auxiliary light for the automatic focusing control is selected as the application, and
(d) display the object to be photographed as the display image when the display of the object to be photographed is selected as the application.

4. An auxiliary light irradiating device for a photographing device according to claim 1, wherein the light source comprises a light source for irradiating an auxiliary light for an automatic focusing control,
the input application is for increasing an automatic focusing speed, and
the control section controls the liquid crystal panel so as to display as the display image a predetermined image for increasing the automatic focusing speed.

5. An auxiliary light irradiating device for a photographing device according to claim 4, wherein the control section controls the liquid crystal panel so as to display the image such that the size of the image displayed is increased as the distance to the object increases.

6. An auxiliary light irradiating device for a photographing device according to claim 1, wherein the control section controls the light source so that a light emitting state is changed according to the application indicated by the application information.

7. An auxiliary light irradiating device for a photographing device according to claim 1, wherein the liquid crystal panel comprises a color liquid crystal panel.

8. A photographing device comprising the auxiliary light irradiating device according to claim 1.

9. A photographing device according to claim 8, wherein the photographing device comprises a digital camera.

10. A method of controlling an auxiliary light irradiating device for a photographing device having a light source for irradiating an auxiliary light toward an object to be photographed and having a liquid crystal panel provided in a light path of the auxiliary light from the light source toward the object, and the liquid crystal panel being configured to displaying an image at a predetermined resolution, the method comprising:
inputting application information indicating an application of the liquid crystal panel; and
controlling the liquid crystal panel so that a display image is changed according to the application indicated by the application information.

11. A method according to claim 10, wherein the light source comprises a light source for a strobe light,
the application is selected from any one of (a) display of remaining time during self-timer photographing, (b) presentation of a photographing timing during the self-timer photographing, (c) irradiation of the auxiliary light for an automatic focusing control, and (d) display of the object to be photographed when photographing a photographer, and
the controlling comprises controlling the liquid crystal panel so as to
(a) display the remaining time as the display image when the display of the remaining time is selected as the application,
(b) display, as the display image, an image of a color predetermined as a color indicating the photographing timing when the presentation of the photographing timing is selected as the application,
(c) display, as the display image, an image of a color predetermined as a color of the auxiliary light when the irradiation of the auxiliary light for the automatic focusing control is selected as the application, and
(d) display the object to be photographed as the display image when the display of the object to be photographed is selected as the application.

12. A method according to claim 10, wherein the light source comprises a light source for irradiating an auxiliary light for an automatic focusing control,
the input application is for increasing an automatic focusing speed, and
the controlling comprises controlling the liquid crystal panel so as to display as the display image a predetermined image for increasing the automatic focusing speed.

13. A method according to claim 12, wherein the controlling comprises controlling the liquid crystal panel so as to display the image such that the size of the image displayed is increased as the distance to the object increases.

14. A method according to claim 10, wherein the controlling comprises controlling the light source so that a light emitting state is changed according to the application indicated by the application information.

15. A storage medium storing a program for controlling an auxiliary light irradiating device for a photographing device having a light source for irradiating an auxiliary light toward an object to be photographed and having a liquid crystal panel provided in a light path of the auxiliary light from the light source toward the object, the liquid crystal panel being configured to displaying an image at a predetermined resolution, and the program causing the auxiliary light irradiating device to execute processing comprising:
inputting application information indicating an application of the liquid crystal panel; and
controlling the liquid crystal panel so that a display image is changed according to the application indicated by the application information.

16. A storage medium storing a program according to claim 15, wherein the light source comprises a light source for a strobe light,
the application is selected from any one of (a) display of remaining time during self-timer photographing, (b) presentation of a photographing timing during the self-timer photographing, (c) irradiation of the auxiliary light for an automatic focusing control, and (d) display of the object to be photographed when photographing a photographer, and
the controlling comprises controlling the liquid crystal panel so as to
(a) display the remaining time as the display image when the display of the remaining time is selected as the application,
(b) display, as the display image, an image of a color predetermined as a color indicating the photographing timing when the presentation of the photographing timing is selected as the application,
(c) display, as the display image, an image of a color predetermined as a color of the auxiliary light when the irradiation of the auxiliary light for the automatic focusing control is selected as the application, and
(d) display the object to be photographed as the display image when the display of the object to be photographed is selected as the application.

17. A storage medium storing a program according to claim 15, wherein the light source comprises a light source for irradiating a auxiliary light for an automatic focusing control,
the input application is for increasing an automatic focusing speed, and
the controlling comprises controlling the liquid crystal panel so as to display as the display image a predetermined image for increasing the automatic focusing speed.

18. A storage medium storing a program according to claim 17, wherein the controlling comprises controlling the liquid crystal panel so as to display the image such that the size of the image displayed is increased as the distance to the object increases.

19. A storage medium storing a program according to claim 15, wherein the controlling comprises controlling the light source so that a light emitting state is changed according to the application indicated by the application information.
